(19) United States
(12) Patent Application Publication
(10) Pub. No.: US 2009/0311430 A1
(43) Pub. Date: Dec. 17, 2009

(54) COATING APPARATUS AND COATING METHOD

(76) Inventor: Hideki ITO, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/484,459

(22) Filed: Jun. 15, 2009

(30) Foreign Application Priority Data
Jun. 16, 2008 (JP) 2008-157081
May 27, 2009 (JP) 2009-127271

(51) Int. Cl. B05D 3/00; B05C 13/02; B05C 11/00

(52) U.S. Cl. 427/314; 118/58; 118/712

(57) ABSTRACT

According to a coating method of the present invention, a second member 107 associated with the type of a silicon wafer 101 to be coated is selected, transferred into a coating chamber 102, and placed on a first member 103 thereby forming a susceptor 110. The associated second member 107 is most suitable for providing a uniform temperature distribution across the surface of the silicon wafer 110 and has a nonuniform thickness designed to correct the uniformity of the temperature distribution across the wafer. This arrangement allows minimization of the temperature variation across the surface of different types of silicon wafers 101 when a film is formed on them. The storage chamber 130 preferably includes heating means 131 for heating the second member.

### BACKGROUND OF THE INVENTION

1. Field of the Invention

The present invention relates to a coating apparatus and a coating method.

2. Background Art

Epitaxial growth techniques are widely used to manufacture semiconductor devices requiring a relatively thick crystalline coating or film, such as power devices, including IGBTs (Insulated Gate Bipolar Transistors).

When using an epitaxial growth technique, it is important to equalize the temperature throughout the wafer. The reason for this is that if the temperature distribution across the wafer is not uniform, then the formed film on the wafer does not have a uniform thickness. Particularly, when an epitaxial wafer coated with a thick film is manufactured, even slight nonuniformity in the wafer temperature may significantly reduce the uniformity of the film thickness since the epitaxial growth process takes considerable time to complete.

Japanese Laid-Open Patent Publication No. 2007-258694 discloses a vapor phase growth apparatus which includes a first holder on which a wafer is placed and a second holder for supporting the first holder, which arrangement prevents escape of heat from the edge portions of the wafer and consequent reduction of the uniformity of the film thickness at these portions. The first holder is made of a material having a higher thermal conductivity than the second holder, thereby increasing the heat transmission from the first holder to the wafer and reducing the heat dissipation from the second holder.

This approach, however, still cannot provide a uniform temperature distribution across the wafer, since degradation in the uniformity of the wafer temperature may result from causes other than the reduction of the temperature of the edge portions of the wafer and since each type of wafer exhibits a different temperature distribution pattern. For this reason, it has been found that the vapor phase growth apparatus disclosed in the above publication may fail to achieve a uniform temperature distribution across the wafer.

### SUMMARY OF THE INVENTION

The present invention has been made to overcome the foregoing problems. It is, therefore, an object of the present invention to provide a coating apparatus capable of forming a film on any suitable type of wafer while minimizing the temperature variation across the wafer.

Another object of the present invention is to provide a coating method capable of forming a film on any suitable type of wafer while minimizing the temperature variation across the wafer.

According to one aspect of the present invention, a coating apparatus comprises a coating chamber for containing a substrate, a susceptor adapted to be disposed in the coating chamber to support the substrate, the susceptor corresponding to the type of the substrate, a first heating unit for heating the substrate supported by the susceptor, a storage chamber disposed outside the coating chamber to store the susceptor, a standby chamber connected through an on-off unit to the coating chamber, and transfer means for retrieving the susceptor from the storage chamber and transferring the susceptor to the coating chamber through the standby chamber.

According to another aspect of the present invention, a coating apparatus comprises a coating chamber for containing a substrate, a first member disposed in the coating chamber to support the substrate, a first heating unit for heating the substrate supported by the first member, a second member adapted to be supported by the first member and to be disposed between the substrate and the first heating unit, the second member corresponding to the type of the substrate, a storage chamber disposed outside the coating chamber to store the second member, a standby chamber connected through an on-off unit to the coating chamber, and transfer means for retrieving the second member from the storage chamber and transferring the second member to the coating chamber through the standby chamber.

According to another aspect of the present invention, in a coating method that transfers a substrate into a coating chamber including a first heating unit, supports the substrate on a susceptor, and forms a film on the substrate, the susceptor is stored in a storage chamber including a second heating unit. The susceptor is corresponded to the type of the substrate. The susceptor is retrieved, and is transferred to a standby chamber connected through an on-off unit to the coating chamber. The susceptor is transferred from the standby chamber to the coating chamber.

According to other aspect of the present invention, in a coating method that transfers a substrate into a coating chamber including a first heating unit, supports the substrate on a first member, and forms a film on the substrate, the second member is stored in a storage chamber including a second heating unit. The second member is corresponding to the type of the substrate. The second member is retrieved from the storage chamber and is transferred the second member to a standby chamber connected through an on-off unit to the coating chamber. The second member is transferred from the standby chamber to the coating chamber. The second member is supported on the first member such that the second member is disposed between the substrate and the first heating unit. The film is formed on the substrate.

Other objects and advantages of the present invention will become apparent from the following description.

### BRIEF DESCRIPTION OF THE DRAWINGS

FIG. 1 is a schematic conceptual view of a coating apparatus of a single wafer processing type according to a first embodiment of the present invention.

FIG. 2 is a cross-sectional view of the configuration of a coating chamber used to implement a second coating method according to the first embodiment.

FIG. 3 includes an enlarged cross-sectional view and a corresponding top view of a first member of the susceptor provided in the coating chamber of the first embodiment.

FIG. 4 is an enlarged cross-sectional view showing the susceptor of the first embodiment with a silicon wafer placed thereon.

FIG. 5 is a simulation graph showing the temperature distributions across a plurality of silicon wafers when they are heated using a second member having a flat surface.

FIG. 6 is a schematic cross-sectional view and a corresponding top view of another second member.

FIG. 7 is a cross-sectional view showing the another second member mounted on the first member.

FIG. 8 is a flowchart illustrating the process steps of a coating method of the first embodiment.

FIG. 9 is a schematic cross-sectional view of a storage chamber.

FIG. 10 is a cross-sectional view of components near a first member according to a second embodiment of the present invention.

### DETAILED DESCRIPTION OF THE EMBODIMENTS

### First Embodiment

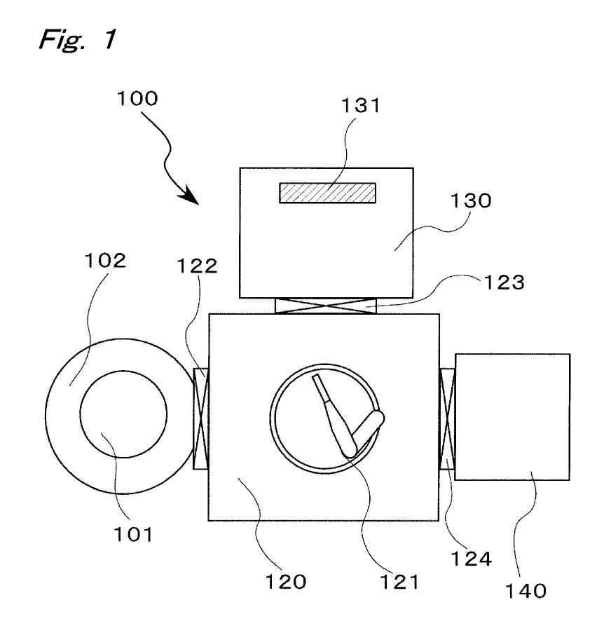

FIG. 1 is a schematic conceptual view of a coating apparatus 100 of a single wafer processing type according to a first embodiment of the present invention. The substrate of the present embodiment described herein is a silicon wafer 101. However, the embodiment is not limited to this particular substrate, but may be applied to wafers of other suitable material depending on the application intended.

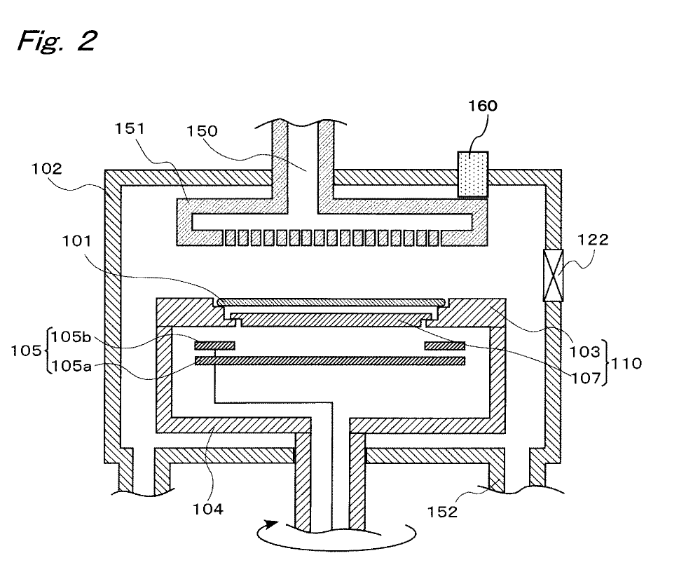

Further, FIG. 2 is a cross-sectional view of the configuration of a coating chamber 102 used to implement a second coating method according to the present invention. In the coating chamber 102 of the present embodiment, a susceptor 110 includes a first member 103 for supporting the silicon wafer 101, and a second member 107 supported by the first member 103 and disposed between the silicon wafer 101 and a first heating unit 105. The second member 107 has a configuration designed to correct the uniformity of the temperature distribution across the silicon wafer 101 generated by the heat from the first heating unit 105.

The coating apparatus 100 includes a standby chamber 120. Further, the coating chamber 102, a storage chamber 130, and a load-lock chamber 140 are disposed around the standby chamber 120 and communicate with the standby chamber 120 through transfer paths 122, 123, and 124, respectively, which each have a gate valve serving as an on-off unit for allowing these chambers to be sealed airtight from each other.

Further, a hydrogen (H₂) or nitrogen (N₂) atmosphere is maintained in the coating chamber 102, the standby chamber 120, and the storage chamber 130. Furthermore, pressure control valves and vacuum pumps (not shown) are coupled to these chambers to allow the pressures in the chambers to be adjusted to the desired level or equalized. In this example, the pressure in each chamber is adjusted to approximately 700 Torr, which is slightly lower than the atmospheric pressure.

A transfer mechanism 121 serving as transfer means is provided in the standby chamber 120. Silicon wafers 101 are delivered into the load-lock chamber 140 from outside the coating apparatus 100, and the transfer mechanism 121 transfers these wafers into the coating chamber 102 one at a time. The transfer mechanism 121 also retrieves a silicon wafer 101 from the coating chamber 102 after a film has been formed on the wafer, and transfers it to the load-lock chamber 140. The silicon wafer 101 is then transferred from the load-lock chamber 140 to outside the coating apparatus 100.

Further, the transfer mechanism 121 can transfer the second member 107 from the storage chamber 130 to the coating chamber 102.

As described later, the storage chamber 130 stores different types of second members including the second member 107. Each second member is associated with or corresponds to a different type of silicon wafer. The storage chamber 130 contains a second heating unit 131 to heat the second members stored in the chamber to a predetermined temperature. This heating prevents a drastic change in the temperature of these second members and the consequent thermal stress damage to them when they are transferred into the coating chamber 102.

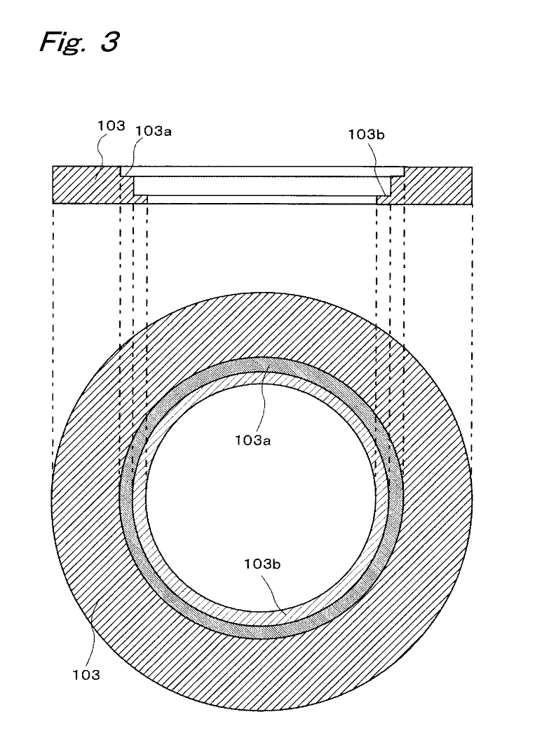

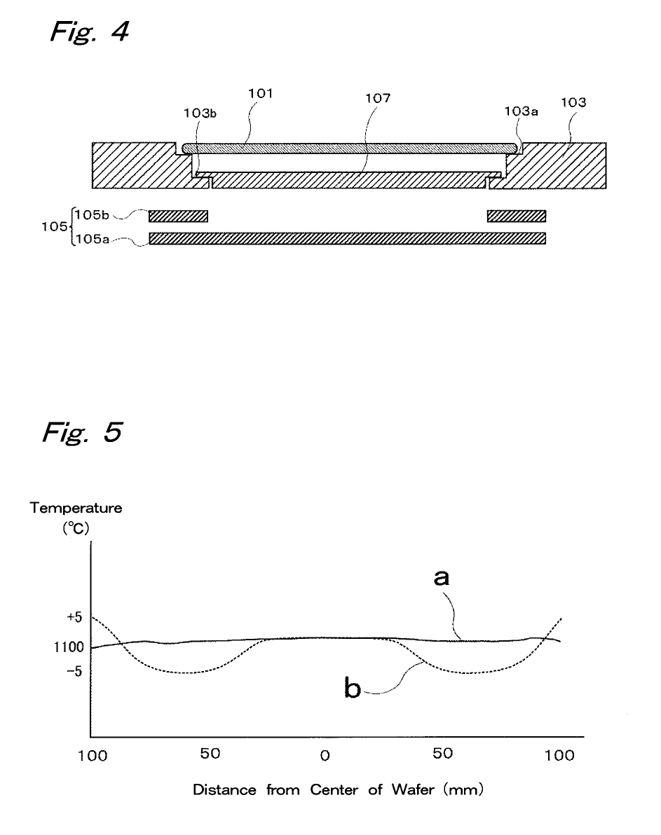

FIG. 3 includes an enlarged cross-sectional view and a corresponding top view of the first member 103 of the susceptor 110 provided in the coating chamber 102. FIG. 4 is an enlarged cross-sectional view showing the susceptor 110 with a silicon wafer 101 placed thereon.

The coating chamber 102 receives a silicon wafer 101 from the transfer mechanism 121 and is used to form a crystalline film on the wafer. In this example, the coating apparatus 100 is of a single wafer processing type in which the silicon wafer 101 is placed substantially horizontally on the susceptor 110 and coated with a film. It is to be understood, however, that there is no limitation as to the manner in which the silicon wafer 101 is received by the coating chamber 102 and placed on the susceptor 110.

In the coating chamber 102, the first member 103 of SiC (silicon carbide), on which the silicon wafer 101 is placed, is disposed on the top of an approximately cylindrical rotating portion 104 of SiC. The silicon wafer 101 is transferred through the transfer path 122 into the coating chamber 102 by the transfer mechanism 121 and placed on the first member 103.

The lower portion of the rotating portion 104 is smaller in diameter than its upper portion and is connected to a rotating mechanism (not shown) outside the coating chamber 102. This enables the rotating portion 104 to be rotated at a predetermined speed about an axis extending perpendicularly through the center of the horizontal cross-section of the rotating portion 104.

The first member 103 is of ring shape with an opening at its center, and is fixed at its peripheral portion to the top of the rotating portion 104. Upper and lower countersinks are formed in the inner edge portion of this ring-shaped first member 103.

The silicon wafer 101 is placed on the upper countersink, which is referred to herein as the first countersink 103a. The first countersink 103a has an inner diameter only slightly larger than the diameter of the silicon wafer 101, thereby restricting the horizontal and approximately horizontal movement of the silicon wafer 101.

Further, the depth from the top surface of the first member 103 to the horizontal bottom surface of the first countersink 103a is approximately equal to or smaller than the thickness of the silicon wafer 101. Therefore, when the silicon wafer 101 is placed on the first countersink 103a, the top surface of the silicon wafer 101 is approximately level with or higher than the top surface of the first member 103. As a result, when the supplied coating gas, or film-forming gas, flows from the center portion to the peripheral portion of the surface of the silicon wafer 101, it does not hit the vertical surface of the first countersink 103a, resulting in a smooth flow of the coating gas.

A second member 107 associated with or corresponding to the type of the silicon wafer 101 to be placed in the coating chamber 102 is transferred into the chamber and placed on the lower countersink, which is referred to herein as the second countersink 103b.

The second member 107 has a greater diameter than the opening formed at the center of the ring-shaped first member 103, and its perimeter portion is formed into a flange shape. This allows the second member 107 to be suspended on the horizontal surface of the second countersink 103b. That is, the second member 107 covers the opening of the first member 103.

The combination of the first member 103 and the second member 107 placed on the second countersink 103b forms the susceptor 110. The susceptor 110 forms a partition which substantially separates the region in which a film is formed on the silicon wafer 101 from the inner region of the rotating portion 104. As a result, impurities originating from the components disposed inside the rotating portion 104 are prevented from entering the region in which the film is formed. This prevents impurities from mixing into the crystalline film formed on the silicon wafer 101, and prevents consequent degradation of the quality of the crystalline film.

Further, the susceptor 110 is made up of the first and second members 103 and 107, and the upward vertical movement of the first member 103 is not restricted by the rotating portion 104 in the coating chamber 102, i.e., the first member 103 is detachable. Therefore, for example, the first member 103, together with the second member 107, may be stored in the storage chamber 130.

In such a case, both the first and second members 103 and 107 are transferred from the storage chamber 130 into the coating chamber 102 through the standby chamber 120, and then the second member 107 is supported on the first member 103 in the manner described above.

The silicon wafer 101 is heated by the first heating unit 105, which includes an inner heater 105a and an outer heater 105b disposed below the silicon wafer 101. Since in the present embodiment the second member 107 is disposed between the first heating unit 105 and the silicon wafer 101, the silicon wafer 101 receives heat from the first heating unit 105 through the second member 107. At that time, the amount of radiant heat transmitted from the second member 107 to the silicon wafer 101 increases as the silicon wafer 101 is located closer to the second member 107. That is, the smaller the distance between the silicon wafer 101 and the second member 107, the more radiant heat is transmitted from the second member 107 to the silicon wafer 101, even if the temperature of the first heating unit 105 is maintained constant. Therefore, the temperature of a selected portion of the silicon wafer 101 may be increased by locally increasing the thickness of the second member 107 so as to reduce the distance between the second member 107 and the selected portion of the silicon wafer 101.

Conversely, the amount of radiant heat transmitted from the second member 107 to the silicon wafer 101 decreases as the top surface of the second member 107 is located more remote from the silicon wafer 101. That is, the greater the distance between the silicon wafer 101 and the second member 107, the less radiant heat is transmitted from the second member 107 to the silicon wafer 101, even if the temperature of the first heating unit 105 is maintained constant. Therefore, the heat applied to a selected portion of the silicon wafer 101 may be reduced by locally reducing the thickness of the second member 107 so as to increase the distance between the second member 107 and the selected portion of the silicon wafer 101.

A coating gas supply portion 150 is provided at the top of the coating chamber 102 to supply a coating gas to the surface of the silicon wafer 101 in order to form a crystalline film thereon. A shower plate 151 having a large number of coating gas discharge holes formed therein is connected to the end of the coating gas supply portion 150 that faces the silicon wafer 101. The shower plate 151 is disposed to face the silicon wafer 101 to supply a coating gas to the surface of the wafer.

A plurality of exhaust portions 152 are provided at the bottom of the coating chamber 102 to exhaust gas from the coating chamber 102. The exhaust portions 152 are connected to a vacuum pump and an exhaust mechanism (not shown) to exhaust coating gas out of the coating apparatus 100 after the gas was used to form a film.

An example will now be described in which a second member having a uniform thickness is used to form a film.

The second member 107 shown in FIGS. 2, 3, and 4 has a uniform thickness and a configuration such that it can radiate heat uniformly over the entire surface of the silicon wafer 101.

FIG. 5 is a simulation graph showing the temperature distributions across a plurality of types of silicon wafers when they are heated using the second member 107 having a flat surface.

In the graph of FIG. 5, solid line a indicates the temperature distribution across an 8 inch silicon wafer 101 (having a diameter of approximately 200 mm) doped with a P-type impurity such as boron to a concentration of approximately 10¹⁸/cm³ (hereinafter referred to as a P⁺-wafer 101). When the P⁻-wafer 101 is heated through the second member 107, the temperature across the entire wafer surface varies only within the range of the preset temperature (1100° C.)±1° C., that is, the temperature distribution across the wafer is substantially uniform, as indicated by the solid line a.

With this uniform temperature distribution across the P⁺-wafer 101, a coating gas may be supplied to form a good quality crystalline film uniformly over the entire surface of the wafer.

The following is another example in which a second member having a nonuniform thickness is used to form a film.

Dotted line b in FIG. 5 indicates the temperature distribution across an 8 inch silicon wafer doped with a P-type impurity to a concentration of approximately 10¹⁶/cm³ or less (hereinafter referred to as a P⁻-wafer 101′). When the P⁻-wafer 101′ is heated through the second member 107 having a flat surface, the near-center portion of the wafer is at a temperature approximately equal to the preset or predetermined temperature, as indicated by the dotted line b. However, the portion of the wafer approximately 50 mm from the center of the wafer is at a temperature approximately 5° C. or less lower than the preset temperature, and furthermore the peripheral portion of the wafer is at a temperature approximately 5° C. or less higher than the preset temperature. That is, when the P⁻-wafer 101′ is heated through the flat second member 107, the radial temperature distribution across the wafer is such that the temperature varies by 10° C. at most.

To overcome this problem, instead of the second member 107 having a uniform thickness, a second member 107′ having a nonuniform thickness is used to form a film on the P⁻-wafer 101′. Specifically, the second member 107 is suitable for film formation on P⁺-wafer 101, but is not suitable for film formation on the P⁻-wafer 101′, as described above. Therefore, the second member 107′, which is suitable for film formation on the P⁻-wafer 101′, is retrieved from the storage chamber 130 and transferred into the coating chamber 102 by the transfer mechanism 121.

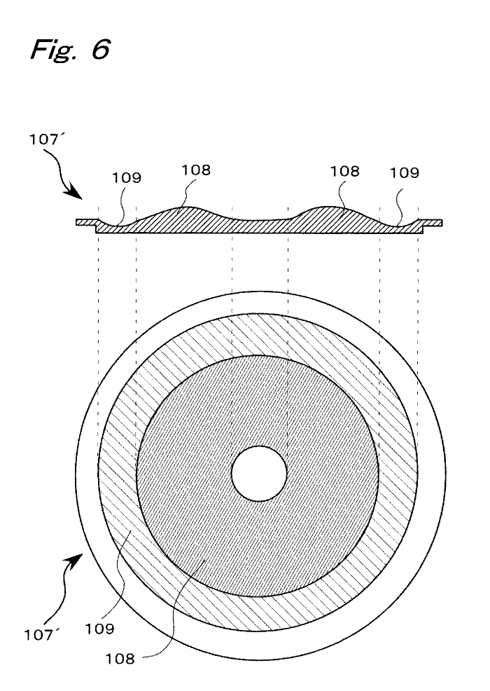

FIG. 6 is a schematic cross-sectional view and a corresponding top view of the second member 107′. As shown in FIG. 6, the second member 107′ has a nonuniform thickness and includes a convex portion 108 and a concave portion 109. That is, the surface of the convex portion 108 is located at a small distance from the P⁻-wafer 107′ and the surface of the concave portion 109 is located at a large distance from the wafer when the wafer is placed on the susceptor. In the top view of FIG. 6, the convex portion 108 and the concave portion 109 are defined by virtual boundaries indicated by solid lines and are differently hatched for clarity. It should be noted, however, that there are no clear boundaries between the convex portion 108 and the concave portion 109 and the flat portions of the second member 107′, since these portions are smoothly contiguous with each other, as can be seen from the cross-sectional view of FIG. 6. Since a concentric temperature distribution occurs across the P⁻-wafer 101′, the convex portion 108 and the concave portion 109 are concentrically formed.

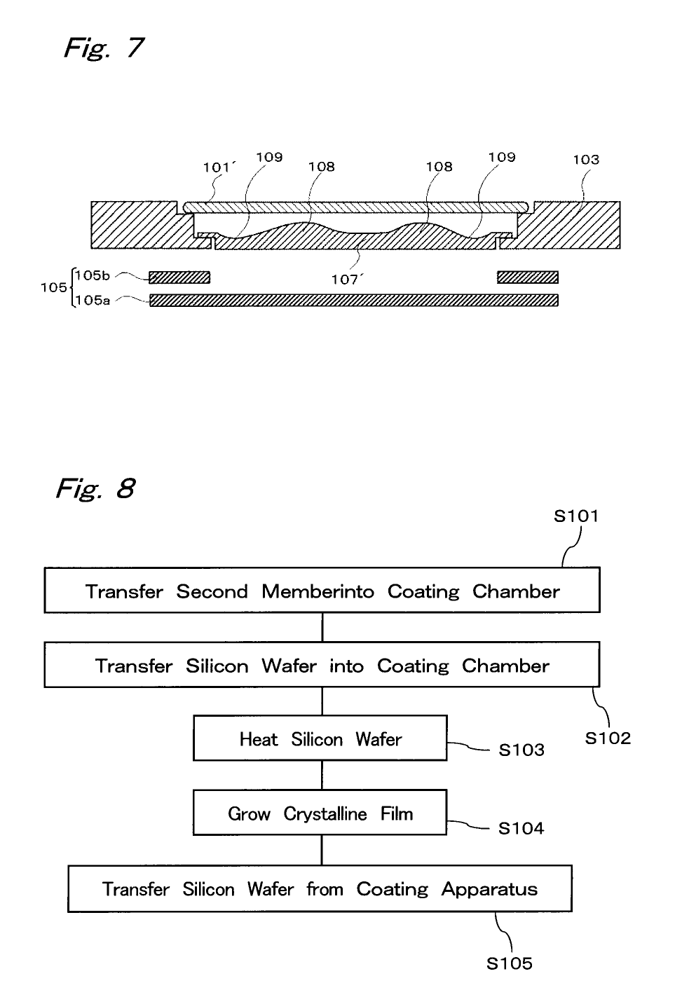

FIG. 7 is a cross-sectional view showing the second member 107′ mounted on the first member 103.

As described above, the amount of radiant heat transmitted from the second member to the silicon wafer varies with the distance between them. Therefore, the second member may be selected to have a nonuniform thickness such that the distance between the second member and the silicon wafer varies across their surfaces so as to correct the uniformity of the temperature distribution across the silicon wafer. This ensures a uniform temperature distribution across the silicon wafer.

Specifically, the convex portion 108 of the second member 107′ is located immediately below the region of the P⁻-wafer 101′ that is at a lower temperature than the preset temperature, while the concave portion 109 of the second member 107′ is located immediately below the region of the P⁻-wafer 101′ that is at a higher temperature than the preset temperature. Thus, the second member 107′ is selected to have a configuration such that the amount of radiant heat transmitted from the second member 107′ to the P⁻-wafer 101′ varies across the surface of the P⁻-wafer 101′ so as to achieve a uniform temperature distribution across the surface of the wafer.

In other words, the second member 107′ has a cross-sectional shape designed to correct the uniformity of the temperature distribution across the wafer 101. More specifically, the vertical cross section of the second member 107′ at its center has a shape that is similar or corresponds to the inverse of the curve indicated by dotted line b in FIG. 5.

Such a cross-sectional shape of the second member 107′ can be determined using data on the temperature distribution across the silicon wafer when the wafer is heated through the second member 107 having a uniform thickness. By using this second member 107′, it is possible to achieve a uniform temperature distribution across the silicon wafer.

The storage chamber 130 may store as many such second members as there are types of silicon wafers used. This allows the use of the most suitable second member for forming a film on a particular type of silicon wafer. As a result, any suitable type of silicon wafer can be uniformly heated, resulting in formation of a good quality crystalline film on the wafer.

Further, according to the present embodiment, the second member can be replaced without stopping an ordinary production run, thus eliminating the need for labor to take apart equipment, etc., in order to replace the second member. Thus, the present embodiment enables the coating apparatus to be adjusted to provide a uniform temperature distribution across a silicon wafer of any characteristics while maintaining the production at a high operating rate.

FIG. 8 is a flowchart illustrating the process steps of a coating method according to the present embodiment.

The coating method of one aspect of the present embodiment includes the following steps.

The method begins by selecting the second member 107 most adapted to provide a uniform temperature distribution across the silicon wafer 101 to be coated when the wafer is heated through the second member 107. This second member 107 is transferred from the storage chamber 130 through the standby chamber 120 into the coating chamber 102 by the transfer mechanism 121 and mounted on the second countersink 103b of the first member 103, completing the assembly of the susceptor 110 (step S101).

At that time, the inside of the coating chamber 102 is at a temperature lower than the deposition temperature (or preset temperature) but not lower than, e.g., 700° C. Such a temperature is high enough to cause thermal stress to the second member 107 if the member is at ambient temperature when it is transferred into the coating chamber 102. The present embodiment avoids this by heating the second member 107 to approximately 700-800° C. in the storage chamber using the second heating unit 131 beforehand. This heating prevents a drastic change in the temperature of the second member 107 and the consequent thermal stress damage to it.

Next, the silicon wafer 101, after being supplied to the load-lock chamber 140, is transferred into the coating chamber 102 by the transfer mechanism 121 and placed on the first countersink 103a of the first member 103 (S102).

Then, the temperature of the first heating unit 105 is raised to heat the second member 107. The heated second member 107 substantially serves as a heater for the silicon wafer 101 and radiates heat to the wafer. Thus, the silicon wafer 101 placed on the first member 103 is gradually heated to the preset temperature (S103).

After the silicon wafer 101 has been heated to the preset temperature (e.g., 1100° C.), a crystalline film forming process is initiated by supplying a coating gas from the shower plate 151 (S104). This enables a good quality crystalline film to be formed over the entire surface of the silicon wafer 101 since the temperature distribution across the entire surface of the wafer is uniform.

The above film forming process takes, e.g., approximately a few tens of minutes to form a crystalline film on silicon wafer 101 to the desired thickness. The silicon wafer 101 with the crystalline film thereon is then transferred out of the coating chamber 102 by the transfer mechanism 121. The silicon wafer 101 is then delivered into the load-lock chamber 140 and transferred out of the coating apparatus 100 (S105).

The coating apparatus 100 may repeat the above process to form a good quality crystalline film uniformly on a plurality of silicon wafers 101 successively.

If the silicon wafer 101 which is next to be transferred into the coating chamber 102 and which has been delivered into the load-lock chamber 140 has the same characteristics as the previous silicon wafer 101 which has been coated with a film and transferred out of the coating chamber 102, then there is no need to replace the current second member 107 when forming a film on the next silicon wafer 101. On the other hand, if the silicon wafer 101 which is next to be transferred into the coating chamber 102 has different characteristics than the previous silicon wafer 101, then at step S101 the current second member 107 mounted on the first member 103 is replaced by a second member 107′ that is adapted for the characteristics of the next silicon wafer 101.

Thus, the present embodiment allows the use of a second member adapted for the characteristics of the silicon wafer 101 to be coated without the need for labor to take apart the coating apparatus, etc. That is, the present embodiment enables the coating apparatus to be adjusted to form a good quality crystalline film on any suitable type of silicon wafer without reducing the production efficiency.

According to the present embodiment, a radiation thermometer 160 serving as first temperature measuring means is preferably provided in the coating chamber 102 and used to measure the temperature of the first member 103. With this arrangement, the temperature of the second heating unit 131 is preferably adjusted such that the temperature of the second members placed in the storage chamber 130 is equal to the measured temperature of the first member 103. This arrangement results in the following advantage. When, for example, the second member 107′ is transferred into the coating chamber 102 to replace the second member 107, there is no drastic change in the temperature of the second member 107′ and no consequent thermal stress damage to the member, since the second member 107′ has been heated to near the temperature of the first member 103.

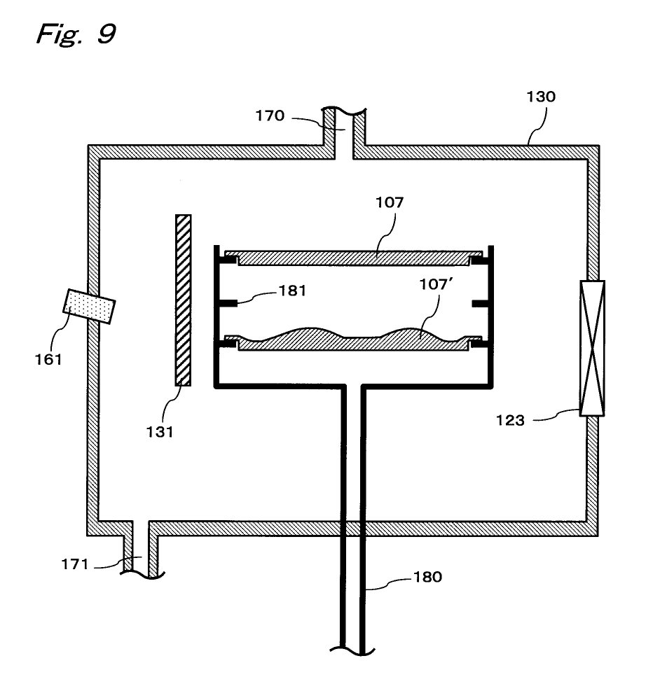

FIG. 9 is a schematic cross-sectional view of the storage chamber 130. Referring to FIG. 9, hydrogen gas or nitrogen gas is introduced into the storage chamber 130 through an introduction port 170. Further, an exhaust port 171 has connected thereto a pressure regulating valve or a vacuum pump (not shown) to adjust the pressure in the storage chamber 130 to the desired value.

The storage chamber 130 contains a susceptor holding member 180, as shown in FIG. 9. The second members 107 and 107′ are held by the susceptor holding member 180. Further, a radiation thermometer 161 serving as second temperature measuring means is disposed in the storage chamber 130 such that the thermometer can measure the temperature of the second members held by the susceptor holding member 180 when they are at a predetermined position.

Based on the temperature of the first member 103 as measured by the radiation thermometer 160 in the coating chamber 102 and based on the temperature of the second members as measured by the radiation thermometer 161 in the storage chamber 130, the temperature of the second heating unit 131 may be adjusted such that the temperature of the second members placed in the storage chamber 130 is approximately equal to the temperature of the first member 103 in the coating chamber 102.

Although the example of FIG. 9 includes only one second heating unit 131 disposed on one side of the susceptor holding member 180, it is to be understood that an additional second heating unit 131 may be provided on the opposite side of the susceptor holding member 180 to more quickly and uniformly heat the second members.

The susceptor holding member 180 is adapted to be lifted in the storage chamber 130. This allows the second member 107 or 107′ to be raised or lowered to a measurement position when its temperature is measured by the radiation thermometer 161. Furthermore, when the second member 107 or 107′ is transferred from the storage chamber 130 to the transfer path 123, the susceptor holding member 180 may be raised or lowered such that the second member is at the same level as the transfer path 123 to allow the transfer mechanism 121 to transfer the second member from the storage chamber 130 to the standby chamber 120 through the transfer path 123. Further, when another second member is transferred into the storage chamber 130 through the transfer path 123, the susceptor holding member 180 may also be raised or lowered such that a holding portion 181 of the susceptor holding member 180 is at the same level as the transfer path 123 to allow the second member to be smoothly transferred to and held by the susceptor holding member 180.

In conventional coating apparatuses, it is not desirable to change the coating or deposition environment before all of the plurality of silicon wafers stacked in the current cassette (not shown) have been processed. This means that it is difficult to process a silicon wafer of a different type than that of the silicon wafers in the current lot before the entire lot has been processed. However, the coating method of the present embodiment enables coating environments to be switched in the middle of an ordinary production run. As a result, a flexible production operation is secured; that is, the production can be such that only the requested number of silicon wafers of the requested type are produced.

Further, even if all of the silicon wafers loaded in a cassette are different in characteristics, it is possible to grow a good quality crystalline film on these wafers by using a different second member 107 for each silicon wafer.

### Second Embodiment

Another preferred embodiment of the present invention will be described.

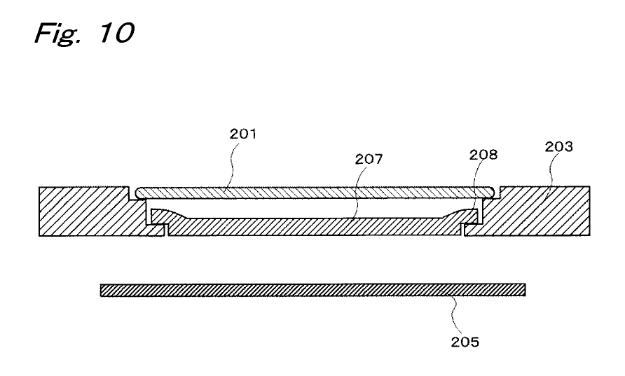

FIG. 10 is a cross-sectional view of components near a first member 203 according to a second embodiment of the present invention.

According to this embodiment, a P⁺-silicon wafer 201 is heated by a first heating unit 205 which includes only an inner heater. A second member 207 mounted on the first member 203 has a convex portion 208 formed at the peripheral portion thereof, and the other portion of the second member 207 is of a flat shape.

In conventional constructions, when the silicon wafer mounted on the first member is heated, heat is dissipated from the surface portion of the wafer in contact with the first member, with the result that that surface portion is lower in temperature that the other portion. The conventional way to solve this problem is to add an outer heater, etc., to achieve a uniform temperature distribution across the surface of the wafer.

However, the use of the second member 207 having the convex portion 208 formed at the peripheral portion thereof allows additional heat to be radiated to the peripheral portion of the silicon wafer 201, thereby compensating for the heat dissipation from that portion of the wafer and maintaining its temperature. This ensures a uniform temperature distribution across the surface of the silicon wafer 201.

Thus the present embodiment enables a good quality crystalline film to be formed on the silicon wafer 201.

Preferred embodiments of the present invention have been described with reference to specific examples.

It is to be understood, however, that the present invention is not limited to these particular embodiments, since various alterations may be made without departing from the spirit and scope of the invention.

For example, according to the first embodiment, the transfer mechanism 121 transfers both the silicon wafer 101 and the second member 107. However, instead, the coating apparatus may include two separate transfer mechanisms which transfer the silicon wafer 101 and the second member 107, respectively. This arrangement eliminates the need to wait for the completion of the transfer of the wafer in order to transfer the second member, and vice versa, which is a waste of time. In this way the lead time can be reduced.

Further, the coating apparatus may include three transfer mechanisms disposed near the transfer paths 122, 123, and 124 to perform transfers to and from the coating chamber 102, the storage chamber 130, and the load-lock chamber 140, respectively. These transfer mechanisms may also exchange second members and silicon wafers with each other before transferring them.

In the first and second embodiments, the storage chamber stores only second members, and one of these second members is transferred to the coating chamber and placed on the first member mounted in the chamber, thus forming a susceptor. In other embodiments, however, the storage chamber may store susceptors each composed integrally of a first member and a second member. With this arrangement, one of these susceptors may be selected for the silicon wafer to be used, and transferred to the coating chamber.

It should be noted that the figures discussed above do not show electric wires and output controllers provided for the first and second heating units 105 and 131 of the present invention, nor do they show the sensor for sensing the surface temperature of the silicon wafer 101.

Although the above embodiments of the present invention have been described with reference to general coating apparatuses and general coating methods, it is to be understood that the invention is not limited to these, but can be applied to epitaxial growth apparatuses for forming a single-crystalline film and to apparatuses for forming a polysilicon film, which results in the same operating advantages as described above in connection with the invention.

The above description of the present invention has not specified apparatus constructions, control methods, etc. which are not essential to the invention, since any suitable apparatus constructions, control methods, etc. can be employed to implement the invention.

The figures used to describe the present invention do not show components which are not essential in describing the invention. Further, these figures are not drawn to scale, and certain features and dimensions are shown in modified or exaggerated form for clarity when appropriate.

Further, the scope of this invention encompasses all coating apparatuses employing the elements of the invention and variations thereof which can be designed by those skilled in the art, and also encompasses the configurations of the components of these apparatuses.

The features and advantages of the present invention may be summarized as follows.

The present invention provides a coating apparatus and coating method capable of forming a film on any suitable type of wafer while minimizing the temperature variation across the wafer.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2008-157081, filed on Jun. 16, 2008 including specification, claims, drawings and summary, on which the Convention priority of the present application is based, are incorporated herein by reference in its entirety.

What is claimed is:

1. A coating apparatus comprising:
a coating chamber for containing a substrate;
a susceptor adapted to be disposed in said coating chamber to support said substrate, said susceptor being associated with or corresponding to the type of said substrate;
a first heating unit for heating said substrate supported by said susceptor;
a storage chamber disposed outside said coating chamber to store said susceptor;
a standby chamber connected through an on-off unit to said coating chamber; and
transfer means for retrieving said susceptor from said storage chamber and transferring said susceptor to said coating chamber through said standby chamber.

2. The coating apparatus according to claim 1, wherein said storage chamber includes a second heating unit.

3. The coating apparatus according to claim 2, further comprising:
first temperature measuring means for measuring the temperature of said susceptor in said coating chamber; and
second temperature measuring means for measuring the temperature of said susceptor in said storage chamber.

4. The coating apparatus according to claim 3, wherein:
said storage chamber includes a susceptor holding member for holding said susceptor; and
said susceptor holding member is adapted to move said susceptor to predetermined positions in said storage chamber.

5. The coating apparatus according to claim 4, wherein said predetermined positions include a position at which a temperature measurement is made by said second temperature measuring means, and a position at which said transfer means can transfer said susceptor to and from said standby chamber.

6. A coating apparatus comprising:
a coating chamber for containing a substrate;
a first member disposed in said coating chamber to support said substrate;
a first heating unit for heating said substrate supported by said first member;
a second member adapted to be supported by said first member and to be disposed between said substrate and said first heating unit, said second member being associated with or corresponding to the type of said substrate;
a storage chamber disposed outside said coating chamber to store said second member;
a standby chamber connected through an on-off unit to said coating chamber; and
transfer means for retrieving said second member from said storage chamber and transferring said second member to said coating chamber through said standby chamber.

7. The coating apparatus according to claim 6, wherein said storage chamber includes a second heating unit.

8. The coating apparatus according to claim 7, further comprising:
first temperature measuring means for measuring the temperature of said first member in said coating chamber; and
second temperature measuring means for measuring the temperature of said second member in said storage chamber.

9. The coating apparatus according to claim 8, wherein:
said storage chamber includes a susceptor holding member for holding said second member; and
said susceptor holding member is adapted to move said second member to predetermined positions in said storage chamber.

10. The coating apparatus according to claim 9, wherein said predetermined positions include a position at which a temperature measurement is made by said second temperature measuring means, and a position at which said transfer means can transfer said second member to and from said standby chamber.

11. A coating method that transfers a substrate into a coating chamber including a first heating unit, supports said substrate on a susceptor, and forms a film on said substrate, said method comprising:
storing said susceptor in a storage chamber including a second heating unit, said susceptor being associated with or corresponding to the type of said substrate;
retrieving said susceptor and transferring said susceptor to a standby chamber connected through an on-off unit to said coating chamber; and
transferring said susceptor from said standby chamber to said coating chamber.

12. The method according to claim 11, wherein the output of said second heating unit is adjusted such that said susceptor is maintained at substantially the same temperature in the storage chamber as in the said coating chamber.

13. A coating method that transfers a substrate into a coating chamber including a first heating unit, supports said substrate on a first member, and forms a film on said substrate, said method comprising:
storing said second member in a storage chamber including a second heating unit, said second member being associated with or corresponding to the type of said substrate;
retrieving said second member from said storage chamber and transferring said second member to a standby chamber connected through an on-off unit to said coating chamber;
transferring said second member from said standby chamber to said coating chamber;
supporting said second member on said first member such that said second member is disposed between said substrate and said first heating unit; and
forming said film on said substrate.

14. The method according to claim 13, wherein the output of said second heating unit is adjusted such that said second member is maintained at substantially the same temperature in the storage chamber as said first member is maintained in the coating chamber.
